(19) United States
(12) Patent Application Publication
(10) Pub. No.: US 2023/0296020 A1
(43) Pub. Date: Sep. 21, 2023

(54) METHOD AND SYSTEM FOR DETERMINING RATIONAL WIDTH OF GOB-SIDE WORKING FACE UNDER CONDITION OF THICK AND HARD KEY STRATA

(71) Applicant: Anhui University of Science and Technology, Huainan (CN)

(72) Inventors: Ming ZHANG, Huainan (CN); Min TU, Huainan (CN); Xiangyang ZHANG, Huainan (CN); Xuelong HU, Huainan (CN); Bin FENG, Huainan (CN); Xinliang ZHANG, Huainan (CN)

(73) Assignee: Anhui University of Science and Technology, Huainan (CN)

(21) Appl. No.: 17/836,273

(22) Filed: Jun. 9, 2022

(30) Foreign Application Priority Data
Feb. 17, 2022 (CN) 202210143947.2

(51) Int. Cl. E21C 39/00; G01V 11/00

(52) U.S. Cl. CPC E21C 39/00; G01V 11/002

(57) ABSTRACT

The present disclosure relates to a method and system for determining a rational width of a gob-side working face under a condition of thick and hard key strata. The method includes: constructing a piecewise function with a width of a gob-side working face as an independent variable; obtaining values of parameters of the gob-side working face; determining a solution set based on the values of the parameters of the gob-side working face, the piecewise function, and a predetermined function threshold; and determining a numerical value according to the solution set as a rational width and mining the gob-side working face according to the rational width.

### CROSS-REFERENCE TO RELATED APPLICATION

This application claims the benefit of priority to Chinese Patent Application No. 202210143947.2, filed on Feb. 17, 2022, which is incorporated herein by reference in its entirety.

### TECHNICAL FIELD

The present disclosure relates to the field of mining engineering, and in particular, to a method and system for determining a rational width of a gob-side working face under a condition of thick and hard key strata.

### BACKGROUND ART

A gob-side working face (the present disclosure is mainly directed to a mining area on a single side and temporarily does not involve gob-side or island working faces under a condition of mining areas on two sides) accounts for 70%-80% of underground mining. Compared with a working face under the condition of entitative coal on two sides (usually a first mining face), the gob-side working face significantly differs in stress environment and the property of inducing rock burst disaster due to stress transfer of the overlying rock above the mining area, and mutual influence, and co-movement and evolution of the spatial structure of the overlying rock during the mining of the gob-side working face.

The width of a gob-side working face is a key indicator that influences the pressure distribution and dynamic disaster manifestation of a mine and may have a great influence on safe mining of the gob-side working face. Accordingly, there is a need for a method for determining a width of a gob-side working face to guide mining.

### SUMMARY

An objective of the present disclosure provides a method and system for determining a rational width of a gob-side working face under a condition of thick and hard key strata that can obtain the rational width of the gob-side working face and thereby realize safe mining of the gob-side working face.

To achieve the above objective, the present disclosure provides the following solutions:

A method for determining a rational width of a gob-side working face under a condition of thick and hard key strata includes:
constructing a piecewise function with a width of a gob-side working face as an independent variable, where the piecewise function represents a relationship among the width of the gob-side working face and parameters of the gob-side working face, the parameters of the gob-side working face including at least a width of a small coal pillar of a gob-side entry, an entry width, a ruptured zone width, a plastic zone width, a uniaxial compressive strength of coal, a buried depth of a coal seam, a fracture angle, an average capacity of overlying rock above a mining area, and a mining area width;
obtaining values of the parameters of the gob-side working face;
determining a solution set based on the values of the parameters of the gob-side working face, the piecewise function, and a predetermined function threshold; and
determining a numerical value according to the solution set as a rational width and mining the gob-side working face according to the rational width.

The piecewise function may be specifically as follows:

$$u \left({d}^{′}\right) = \frac{\left({d}^{′} - a - r - ρ\right) n \left[σ\right]}{\left(1 + K\right) {P}_{1}} , \text{where}$$

when

$$a + r < d ′ < H cot α ,$$

$${P}_{1} = \frac{{{d}^{′}}^{2} \text{-} {\left(a + r\right)}^{2}}{2} γ tan α + \frac{{{d}^{′}}^{2} - {\left(a + r\right)}^{2}}{2 H} Δ σ tan {α}_{{}_{{}_{{}_{;}}}}$$

when

$$H cot α < d ′ < 2 H cot α ,$$

$$\begin{matrix}{P}_{1} = - \frac{{\left(a + r\right)}^{2}}{2} γ tan α - \frac{{\left(a + r\right)}^{2}}{2 H} Δ σ tan α - \frac{γ {H}^{2} tan α}{2} - \\ H Δ σ tan α + γ H {d}^{′} + \frac{3}{2} Δ σ {d}^{′} + \frac{Δ σ {tan}^{2} α}{2 H} {d}^{′} - \frac{Δ σ tan α}{2 H} {{d}^{′}}^{2} ;\end{matrix}$$

and when

$$2 H cot α < d ′ ,$$

$${P}_{1} = \frac{3 γ H + 2 Δ σ}{2} H tan α + γ H D - \frac{{\left(a + r\right)}^{2}}{2} γ tan α - \frac{{\left(a + r\right)}^{2}}{2 H} Δ σ tan α ,$$

where u(d′) represents the piecewise function, while d′ is the width of the gob-side working face, a is the width of the small coal pillar of the gob-side entry, r is the entry width, ρ is a sum of the ruptured zone width and the plastic zone width, n is a confining pressure coefficient for different areas of surrounding rock, [σ] is the uniaxial compressive strength of coal, K is an incremental coefficient for stope dynamic-load stress of the gob-side working face, P₁ is dead load stress of the gob-side working face, H is the buried depth of the coal seam, α is the fracture angle, γ is the average capacity of overlying rock above the mining area, Δσ is a maximum increment of stress transferred from different overlying rock strata above the mining area to the gob-side working face, and D is the mining area width.

The determining the solution set based on the values of the parameters of the gob-side working face, the piecewise function, and the predetermined function threshold may specifically include:
inputting the values of the parameters of the gob-side working face into the piecewise function to obtain a function to be solved; and
performing calculation by letting the function to be solved be less than or equal to the predetermined function threshold to obtain the solution set.

The mining the gob-side working face according to the rational width may specifically include:
determining an actual width of the gob-side working face based on the rational width, the width of the small coal pillar of the gob-side entry, and the entry width; and
mining the gob-side working face according to the actual width.

A system for determining a rational width of a gob-side working face under a condition of thick and hard key strata includes:
a piecewise function constructing module configured to construct a piecewise function with a width of a gob-side working face as an independent variable, where the piecewise function represents a relationship among the width of the gob-side working face and parameters of the gob-side working face, the parameters of the gob-side working face including at least a width of a small coal pillar of a gob-side entry, an entry width, a ruptured zone width, a plastic zone width, a uniaxial compressive strength of coal, a buried depth of a coal seam, a fracture angle, an average capacity of overlying rock above a mining area, and a mining area width;
an obtaining module configured to obtain values of the parameters of the gob-side working face;
a solving module configured to determine a solution set based on the values of the parameters of the gob-side working face, the piecewise function, and a predetermined function threshold; and
a rational width determining module configured to determine a numerical value according to the solution set as a rational width and mine the gob-side working face according to the rational width.

The piecewise function may be specifically as follows:

$$u \left({d}^{′}\right) = \frac{\left({d}^{′} - a - r - ρ\right) n \left[σ\right]}{\left(1 + K\right) {P}_{1}} , \text{where}$$

$${\text{when}}^{a + r < {d}^{′} < H \text{cot} α} ,$$

$${P}_{1} = \frac{{{d}^{′}}^{2} \text{-} {\left(a + r\right)}^{2}}{2} γ tan α + \frac{{{d}^{′}}^{2} \text{-} {\left(a + r\right)}^{2}}{2 H} Δ σ tan α ;$$

$${\text{when}}^{H \text{cot} α < {d}^{′} < 2 H \text{cot} α} ,$$

$$\begin{matrix}{P}_{1} = - \frac{{\left(a + r\right)}^{2}}{2} γ tan α - \frac{{\left(a + r\right)}^{2}}{2 H} Δ σ tan α - \frac{γ {H}^{2} tan α}{2} - \\ H Δ σ tan α + γ H {d}^{′} + \frac{3}{2} Δ σ {d}^{′} + \frac{Δ σ {tan}^{2} α}{2 H} {d}^{′} - \frac{Δ σ tan α}{2 H} {{d}^{′}}^{2} ;\end{matrix}$$

and

$$\text{when} 2 H cot α < d ′ ,$$

$${P}_{1} = \frac{3 γ H + 2 Δ σ}{2} H tan α + γ H D - \frac{{\left(a + r\right)}^{2}}{2} γ tan α - \frac{{\left(a + r\right)}^{2}}{2 H} Δ σ tan α ,$$

where u(d′) represents the piecewise function, while d′ is the width of the gob-side working face, a is the width of the small coal pillar of the gob-side entry, r is the entry width, ρ is a sum of the ruptured zone width and the plastic zone width, n is a confining pressure coefficient for different areas of surrounding rock, [σ] is the uniaxial compressive strength of coal, K is an incremental coefficient for stope dynamic-load stress of the gob-side working face, P₁ is dead load stress of the gob-side working face, H is the buried depth of the coal seam, α is the fracture angle, γ is the average capacity of overlying rock above the mining area, Δσ is a maximum increment of stress transferred from different overlying rock strata above the mining area to the gob-side working face, and D is the mining area width.

The solving module may specifically include:
a function-to-be-solved determining unit configured to input the values of the parameters of the gob-side working face into the piecewise function to obtain a function to be solved; and
a solution set calculating unit configured to perform calculation by letting the function to be solved be less than or equal to the predetermined function threshold to obtain the solution set.

The rational width determining module may specifically include:
an actual width determining unit configured to determine an actual width of the gob-side working face based on the rational width, the width of the small coal pillar of the gob-side entry, and the entry width; and
a mining unit configured to mine the gob-side working face according to the actual width.

According to specific embodiments of the present disclosure, the present disclosure has the following technical effects: the method provided in the present disclosure includes: constructing a piecewise function with a width of a gob-side working face as an independent variable, where the piecewise function represents a relationship among the width of the gob-side working face and parameters of the gob-side working face, the parameters of the gob-side working face including at least a width of a small coal pillar of a gob-side entry, an entry width, a ruptured zone width, a plastic zone width, a uniaxial compressive strength of coal, a buried depth of a coal seam, a fracture angle, an average capacity of overlying rock above a mining area, and a mining area width; obtaining values of the parameters of the gob-side working face; determining a solution set based on the values of the parameters of the gob-side working face, the piecewise function, and a predetermined function threshold; and determining a numerical value according to the solution set as a rational width and mining the gob-side working face according to the rational width. The method allows for mining of a gob-side working face according to a rational width, and can initiatively reduce the level and area of rock burst hazard of the working face, reduce the amount of anti-burst work, and realize effective prevention and control of rock burst.

### BRIEF DESCRIPTION OF THE DRAWINGS

To describe the technical solutions in embodiments of the present disclosure or in the prior art more clearly, the accompanying drawings required in the embodiments will be briefly described below. As will become apparent to those of ordinary skill in the art, the accompanying drawings in the following description show merely some embodiments of the present disclosure, and other drawings can be derived from the accompanying drawings by those of ordinary skill in the art without creative efforts.

FIG. 1 is a flowchart of a method for determining a rational width of a gob-side working face under a condition of thick and hard key strata according to an embodiment of the present disclosure.

FIGS. 2A-2C are schematic diagrams illustrating new classification of rock burst related gob-side working faces.

FIG. 3 illustrates an overlying rock stress transfer model under a condition of non-full mining.

FIG. 4 illustrates an overlying rock stress transfer model under a condition of full mining.

FIG. 5 is a diagram illustrating a calculation model for a pre-mining dead load stress component of a gob-side working face.

FIG. 6 is a schematic diagram block illustrating a system for determining a rational width of a gob-side working face under a condition of thick and hard key strata according to an embodiment of the present disclosure.

FIG. 7 is a schematic block diagram of a computer for implementing the method and the system according to the embodiments of the present disclosure.

### DETAILED DESCRIPTION OF THE EMBODIMENTS

The technical solutions in the embodiments of the present disclosure will be described below clearly and completely with reference to the accompanying drawings in the embodiments of the present disclosure. As will become apparent to persons of ordinary skill in the art, the described embodiments are merely some embodiments rather than all of the possible embodiments of the present disclosure. All other embodiments derived from the embodiments of the present disclosure by a person of ordinary skill in the art without creative efforts shall fall within the protection scope of the present disclosure.

To make the foregoing objective, features, and advantages of the present disclosure clearer and more comprehensible, the present disclosure will be further described in detail below with reference to the accompanying drawings and specific embodiments.

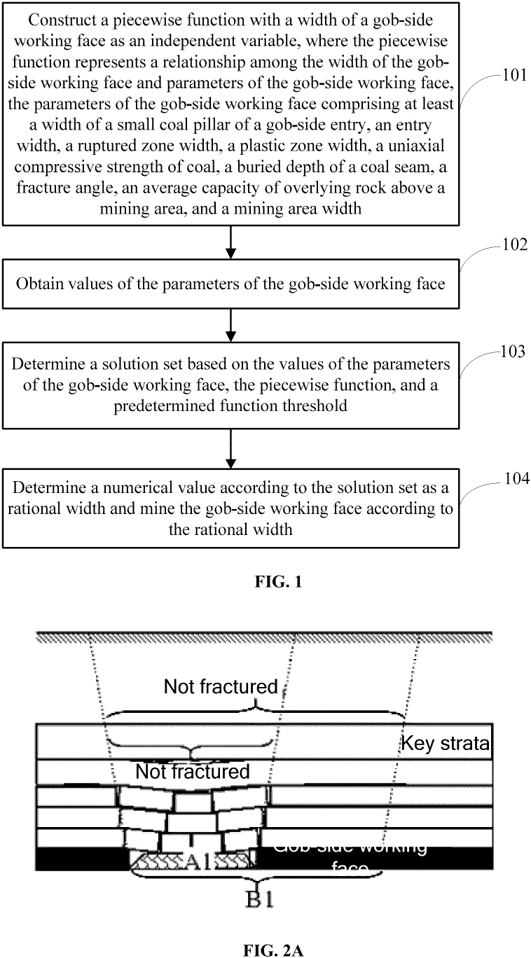

A non-limiting embodiment of the present disclosure provides a method for determining a rational width of a gob-side working face under a condition of thick and hard key strata. As shown in FIG. 1, the method includes:

Step 101: a piecewise function is constructed with a width of a gob-side working face as an independent variable, where the piecewise function represents a relationship among the width of the gob-side working face and parameters of the gob-side working face, the parameters of the gob-side working face including at least a width of a small coal pillar of a gob-side entry, an entry width, a ruptured zone width, a plastic zone width, a uniaxial compressive strength of coal, a buried depth of a coal seam, a fracture angle, an average capacity of overlying rock above a mining area, and a mining area width.

Step 102: values of the parameters of the gob-side working face are obtained.

Step 103: a solution set is determined based on the values of the parameters of the gob-side working face, the piecewise function, and a predetermined function threshold.

Step 104: a numerical value according to the solution set is determined as a rational width and the gob-side working face is mined according to the rational width.

In actual application, the strength theory of rock burst holds that the local stress of coal exceeding the ultimate strength thereof is a critical condition that induces burst. Therefore, under a given coal condition (such as uniaxial compressive strength) of a gob-side working face, the pre-mining distribution feature of the spatial structure of overlying rock above a mining area and the formation-evolution-co-movement law of the spatial structure of the overlying rock of “mining area-working face” during mining determine the supporting stress distribution and the burst risk of the gob-side working face to a large extent. On the basis of the key strata theory in strata control and the spatial structure view of overlying rock, the movement states of the key strata of a stope formed by “mining area-working face” and changes in the spatial structure of the overlying rock before and during mining of a gob-side working face are analyzed, and gob-side working faces are mainly classified into the following three types: “non-full mining (NFM) area on one side → mining of gob-side working face → wide-range non-full mining area” (NFM-NFM), “non-full mining area on one side → mining of gob-side working face → wide-range full mining area” (NFM-FM), and “full mining area on one side → mining of gob-side working face → wide-range full mining area” (FM-FM).

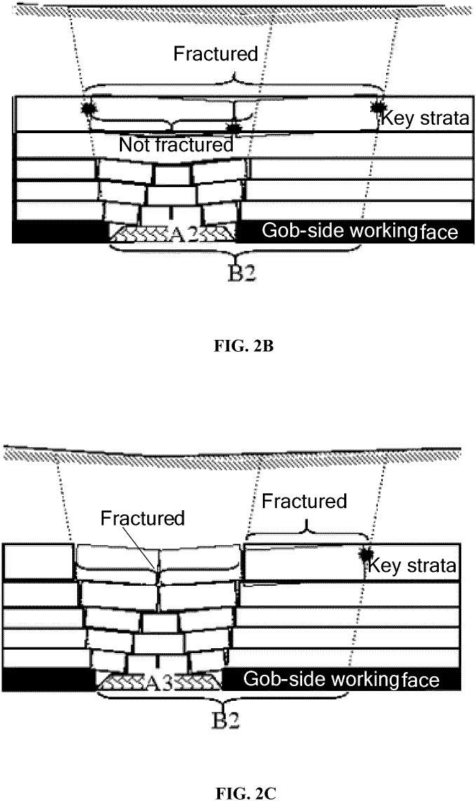

FIG. 2A shows a structure diagram of an NFM-NFM gob-side working face, while FIG. 2B shows a structure diagram of an NFM-FM gob-side working face and FIG. 2C shows a structure diagram of an FM-FM gob-side working face. With the movement state (fractured or stable) of the overlying key strata of a stope as a main feature, there are two types of mining areas on one side of a gob-side working face: non-full mining area and full mining area, namely non-full mining area A1, A2 and full mining area A3. After mining of the gob-side working face, the original mining area and the mining area of the current working face will be gradually communicated with each other, developed, and finally form a new wide-range mining area. Affected by the physical and mechanical features and different occurrence conditions of the key strata and due to the differences of the mining area and the mining scale of the gob-side working face, the overlying key strata of the new mining area may initially fracture, or the overlying key strata of the new mining area may continue to fracture along with the mining of the overlying key strata of the gob-side working face. Therefore, the new mining area can still be divided into non-full mining area B1 and full mining area B2, B3.

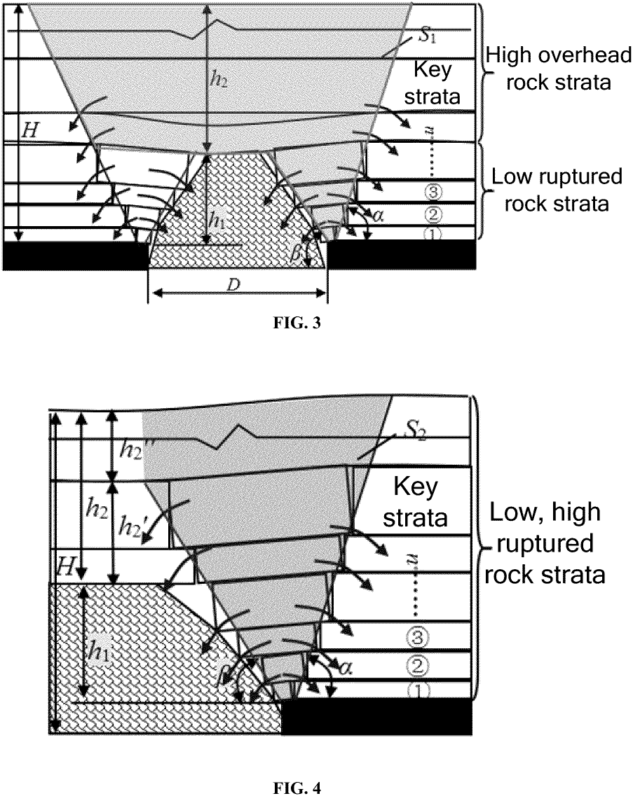

As shown in FIG. 3 and FIG. 4, the mechanism of rock stratum load transfer of a mining area is expressed as follows:

(1) In the height direction, rock strata are classified into high overhead rock strata (not fractured) and low ruptured rock strata (fractured). In case of fractured key strata, the high overhead structure disappears and gradually evolves into “low-high” ruptured rock strata. (2) In the horizontal direction, the low ruptured rock strata form an articulated structure at the boundary of the mining area, and one half of the approximate weight of each rock mass of the articulated structure acts on caved gangue of the mining area on one side, while the other half of the weight acts on the fractured rock strata above coal on one side. The high overhead rock strata averagely act on the rock mass on two sides of the mining area. An included angle between a line connecting the fractured positions of the rock strata on one side of the mining area, which is referred to as an integrated fracture line, and a corresponding horizontal line is called a fracture angle, denoted by α. An included angle between a gangue contact connecting line of articulated rock mass in the mining area and the horizontal direction is called a gangue contact angle, denoted by β. The buried depth of a coal seam is H. In case of non-full mining, the height of a caved zone in the mining area is h₁, while the height from the caved zone to the ground surface h₂ = H - h₁, the mining area width D, and the area of the rock strata acting on the gob-side working face S = S₁/2. In case of full mining, the thickness of the rock strata above the caved zone to the top of the key strata (articulated part) is h₂’, while the thickness of the rock strata from the top of the key strata to the ground surface (the part moving along with the key strata) h₂”, h₂ = h₂’ + h₂”, and the area of the rock strata acting on the gob-side working face S = S₂/2.

According to the area defined by corresponding rock stratum parts, S₁, S₂ are approximated as:

$$\left(\begin{matrix}{S}_{1} = {h}_{2} \left(D + H + {h}_{1} \text{cot} α\right) + \frac{{h}_{1} {}^{2}}{2} \left(cot α + cot β\right) \\ {S}_{2} = \frac{H}{2} \left(H cot α + H cot β + {h}_{n} {}^{′ \text{} ′} cot β\right)\end{matrix}\right\}$$

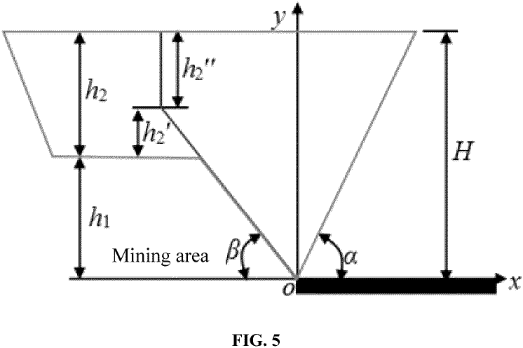

An analytic model for the pre-mining dead load stress of the gob-side working face is established with the length of the gob-side working face as horizontal axis x, the height from the coal seam to the roof as vertical axis y, the junction of the mining area and the gob-side working face as the origin o of coordinates, and an irregular polygon as the contour of the corresponding S₁, S₂ area, as shown in FIG. 5.

The pre-mining dead load stress σ_{J} of the gob-side working face is mainly composed of the geostatic stress σ_{z} of the overlying (not mined) rock strata of the working face, and the stress σ_{T} transferred by the overlying rock strata differently mined in the mining area on one side. Therefore, σ_{J} may be expressed as: σ_{J} =σ_{Z} +σ_{T}. The geostatic stress σ_{z} of the gob-side working face is a piecewise function regarding the length of the working face, which is expressed as:

$${σ}_{z} = \left\{{\begin{matrix}x γ tan α & \left[0 , H cot α\right] \\ γ H & \left(H cot α , + ∞\right)\end{matrix}}_{{}_{{}_{,}}}\right)$$

where γ is the average unit weight of the overlying rock strata, and γ is usually 2.5 t/m³.

A distribution function of the overlying rock strata of the mining area in the gob-side working face is expressed as:

$${σ}_{T} = \left\{\begin{matrix}x tan α \frac{Δ σ}{H} & \left[0 , H cot α\right] \\ \left(2 H - x tan α\right) \frac{Δ σ}{H} & \left(H cot α , 2 H cot α\right] \\ 0 & \left(2 H cot α , + ∞\right) ,\end{matrix}\right)$$

where Δσ is the maximum increment of stress transferred from different overlying rock strata above the mining area to the gob-side working face. The results of Δσ under different mining conditions can be obtained as follows by analysis in accordance with the priorart: Under the condition of non-full mining,

$$Δ σ = \frac{γ {S}_{1}}{2 H cot α} = \frac{γ {h}_{2} \left(D + H + {h}_{1} cot α\right)}{2 H cot α} + \frac{γ {h}_{1}^{2} \left(cot α + cot β\right)}{4 H cot α} .$$

Under the condition of full mining,

$$Δ σ = \frac{γ {S}_{2}}{2 H cot α} = γ \frac{H cot α + H cot β + h 2 ′ cot β}{4 cot α} .$$

From the above results, the pre-mining dead load stress of the gob-side working face under the condition of non-full mining can be determined through the following simultaneous equations:

$${σ}_{J} = {σ}_{Z} + {σ}_{T} ,$$
$${σ}_{Z} = \left\{\begin{matrix}x y tan α \left[0 , H cot α\right] \\ γ H \left(H cot α + ∞\right)\end{matrix}\right) ,$$
$${σ}_{T} = \left\{\begin{matrix}x tan α \frac{Δ σ}{H} \left[0 , H cot α\right] \\ \left(2 H - x tan α\right) \frac{Δ σ}{H} \left(H cot α , 2 H cot α\right] \\ 0 \left(2 H cot α , + ∞\right)\end{matrix}\right) ,$$
and
$$Δ σ = \frac{γ {S}_{1}}{2 H cot α} = \frac{γ {h}_{2} \left(D + H + {h}_{1} cot α\right)}{2 H cot α} + \frac{γ {h}_{1}^{2} \left(cot α + cot β\right)}{4 H c o t α} ,$$
and the pre-mining dead load stress of the gob-side working face under the condition of full mining can be determined through the following simultaneous equations:
$${σ}_{J} = {σ}_{Z} + {σ}_{T} ,$$
$${σ}_{Z} = \left\{\begin{matrix}x y tan α \left[0 , H cot α\right] \\ γ H \left(H cot α + ∞\right)\end{matrix}\right) ,$$
$${σ}_{T} = \left\{\begin{matrix}x tan α \frac{Δ σ}{H} \left[0 , H cot α\right] \\ \left(2 H - x tan α\right) \frac{Δ σ}{H} \left(H cot α , 2 H cot α\right] \\ 0 \left(2 H cot α , + ∞\right)\end{matrix}\right) ,$$
and
$$Δ σ = \frac{γ {S}_{2}}{2 H cot α} = γ \frac{H cot α + H cot β + {h}_{2} {}^{′ \text{} ′} cot β}{4 cot α} .$$

Coal mined in the gob-side working face has supporting stress P and bearing stress (strength) R. The supporting stress P of the coal is mainly determined by external factors such as a mining environment and a mining situation, which are called an “extemal force”. The bearing stress (strength) R of the coal is mainly determined by internal factors such as intrinsic physical and mechanical properties of coal and surrounding rock conditions thereof, which are called an “internal force”. The magnitudes of and the relationship between the “external force” and the “internal force” together determine the coal burst situation of the working face. The source of P mainly includes dead load stress and dynamic load stress. The magnitude of the dead load stress is related to key parameters such as a mining depth, rock stratum occurrence, the distribution of the key strata, a mining situation and the length of the gob-side working face. The dynamic load stress is related to the movement of mining the key strata in the gob-side working face and the changes of the overlying rock structure. Apart from being affected by own mechanics such as coal seam strength of the working face, R is also closely related to factors such as the length of the working face. P and R are specifically analyzed as follows:

The supporting stress P (P₁+P₂) on the coal of the gob-side working face includes the dead load stress formed by the stress transferred by the overlying rock of the mining area and the geostatic stress of the overlying rock of the gob-side working face, and the existing dead load stress from the movement of mining the key strata in the gob-side working face and the movement of the overlying rock structure. The magnitudes of the pre-mining dead load stress σ_{J} of the working face and the dead load stress P₁ of the working face are calculated, respectively.

### Dead Load Stress P₁

1) When d′ meets a+r<d′≤Hcotα, the pre-mining dead load stress of the working face is as follows:

$${σ}_{J} = x γ t a n α + x t a n α {\frac{Δ σ}{H}}_{\left[a + r , {d}^{′}\right]}$$

The magnitude of the dead load stress P₁ of the working face is calculated as follows:

$$\begin{matrix}{P}_{1} = {\int }_{a + r}^{{d}^{′}} \left(x γ tan α + x tan α \frac{Δ σ}{H}\right) \text{d} x = \frac{{{d}^{′}}^{2} \text{-} {\left(a + r\right)}^{2}}{2} γ tan α + \\ \frac{{{d}^{′}}^{2} - {\left(a + r\right)}^{2}}{2 H} Δ σ tan α\end{matrix}$$

2) When d′ meets Hcotα<d′≤2Hcotα, the pre-mining dead load stress of the working face is as follows:

$${σ}_{J} = \left\{\begin{matrix}x γ tan α + x tan α \frac{Δ σ}{H} \left[a + r , H c o t α\right] \\ γ H + \left(2 H - x tan α\right) \frac{Δ σ}{H} \left(H c o t α , {d}^{′}\right]\end{matrix}\right)$$

The magnitude of the dead load stress P₁ of the working face is calculated as follows:

$$\begin{matrix}{P}_{1} = {\int }_{a + r}^{H cot a} \left(x γ tan α + x tan α \frac{Δ σ}{H}\right) \text{d} x + \\ {\int }_{H cot a}^{{d}^{′}} \left[γ H + \left(2 H - x tan α\right) \frac{Δ σ}{H}\right] \text{d} x \\ = - \frac{{\left(a + r\right)}^{2}}{2} γ tan α - \\ \frac{{\left(a + r\right)}^{2}}{2 H} Δ σ tan α - \frac{γ {H}^{2} tan α}{2} - H Δ σ tan α + γ H {d}^{′} + \frac{3}{2} Δ σ {d}^{′} + \\ \frac{Δ σ {tan}^{2} α}{2 H} {d}^{′} - \frac{Δ σ tan α}{2 H} {{d}^{′}}^{2}\end{matrix}$$

3) When d′ meets 2Hcota<d′, the pre-mining dead load stress of the working face is as follows:

$${σ}_{J} = \left\{\begin{matrix}x γ tan α + x tan α \frac{Δ σ}{H} & \left[a + r , H c o t α\right] \\ γ H + \left(2 H - x tan α\right) \frac{Δ σ}{H} & \left(H c o t α , \left(2 H c o t α\right]\right) \\ γ H & \left(2 H c o t α , {d}^{′}\right)\end{matrix}\right)$$

The magnitude of the dead load stress P₁ of the working face is calculated as follows:

$$\begin{matrix}{P}_{1} = {\int }_{a + r}^{H cot a} \left(x γ tan α + x tan α \frac{Δ σ}{H}\right) \text{d} x + \\ {\int }_{H cot a}^{2 H cot a} \left[γ H + \left(2 H - x tan α\right) \frac{Δ σ}{H}\right] \text{d} x + {\int }_{2 H cot a}^{{d}^{′}} γ H \text{d} x = \\ \frac{3 γ H + 2 Δ σ}{2} H tan α + γ H D - \frac{{\left(a + r\right)}^{2}}{2 H} γ tan α - \frac{{\left(a + r\right)}^{2}}{2 H} Δ σ tan α\end{matrix}$$

### Estimation of the Magnitudes of the Dynamic Load Stress P₂ and P

The dynamic load stress P₂ is mainly from the movement of mining the overlying rock strata and determined by geological conditions (key stratum occurrence, physical and mechanical features, etc.) and technical factors (mining intensity, mining methods, etc.). The movement states of the key strata of the mining area and the changes of the overlying rock structure features before and during mining are main causes determining the influence ranges and manifestation extents of mine earthquakes and large-range roof movement. Especially, the fracture movement of the main key stratum can induce strong dynamic pressure of the stope. In case of NFM-NFM, NFM-FM and FM-FM, the incremental coefficient K for stope dynamic-load stress of the gob-side working face (relative to the dead load stress) is K₁, K₂, and K₃, respectively. Generally, K₁, K₂, and K₃ are all greater than 0, and greater values of them indicate stronger overlying rock movement and more obvious mining dynamic load effects, with K₁<K₂<K₃.

The relationship between the dynamic load stress P₂ and P₁ is estimated as: P₂=KP₁. P is the sum of the dead load stress and the dynamic load stress, which is approximately expressed as: P=P₁+P₂=(1+K)P₁.

For a working face under special conditions of not considering coal pillars, boundary coal, etc., the mining working face generally has a length of 80-300 m, which is much greater than the width (usually about 2-10 m) of a plastic zone of coal. Therefore, when the width of the working face is greater than 5-20 m, the working face has complete zones, and from the edge of the mining area, the coal of the working face in the length direction of the working face generally exhibits a distribution feature “ruptured zone-plastic zone-elastic zone-ruptured zone”. According to different coal surrounding rock states, the ultimate supporting stress σ_{S} of the coal of the working face is analyzed to be approximate to symmetrical “trapezoidal” distribution. It is approximated that the elastic zone in the middle of the working face is in a three-dimensional stress state, and its ultimate supporting strength σ_{3C} is about n≈3-5 times the uniaxial compressive strength [σ] of coal, averagely 4, i.e., σ_{3C}≈n[σ]. The rapture of the edge of the working face and the coal of the plastic zone are in a transitional state “unconfined-unidirectional-two-dimensional-three-dimensional”, and the ultimate supporting stress linearly increases from 0 to σ_{3C}. If the width of the ruptured zone and the plastic zone on one side of the working face is ρ, the width of the elastic width is d-2ρ. Accordingly, σ_{S} is approximately expressed as:

$${σ}_{S} = \left\{\begin{matrix}\frac{n \left[σ\right]}{ρ} x \left[0 , ρ\right] \\ n \left[σ\right] \left(ρ , d - ρ\right)\end{matrix}\right)$$

The ultimate bearing stress (strength) R of the gob-side working face is analyzed as follows:

$$\begin{matrix}R = {\int }_{0}^{d} {σ}_{S} \text{d} x = 2 {\int }_{0}^{ρ} \frac{n \left[σ\right]}{ρ} x \text{d} x + \\ {\int }_{ρ}^{{d}^{′} - a - r - 2 ρ} n \left[σ\right] \text{d} x = \left({d}^{′} - a - r - ρ\right) n \left[σ\right]\end{matrix}$$

For the purpose of realizing effective prevention and control of rock burst of the working face, the pre-mining dead load stress of the working face is considered comprehensively, and the supporting stress P and the ultimate bearing stress (strength) R of the coal of the gob-side working face and the relationship therebetween are comparatively studied to provide mechanical basis and engineering criteria for determining the rational length of the gob-side working face. By analysis from the perspective of “stress”, the requirement or condition to be met is approximately described as: the bearing stress (including dead load stress and dynamic load stress, and denoted by P) exerted on the coal of the working face is lower than the own ultimate bearing stress (strength) (denoted by R) of the coal, i.e., P<R; the ratio of R/P reflects the macroscopic stress state and the burst risk level of the working face; and it is assumed that function u (d′) regarding d′(d′=d+α+r) is

$$u \left({d}^{′}\right) = R / P = \frac{\left({d}^{′} - a - r - ρ\right) n \left[σ\right]}{\left(1 + K\right) {P}_{1}} .$$

In conclusion, the piecewise function is specifically as follows:

$$u \left({d}^{′}\right) = \frac{\left({d}^{′} - a - r - ρ\right) n \left[σ\right]}{\left(1 + K\right) {P}_{1}} , \text{where}$$

when

$$a + r < d ′ < H cot α ,$$

$${P}_{1} = \frac{{d}^{′ 2} - {\left(a + r\right)}^{2}}{2} γ tan α + \frac{{d}^{′ 2} - {\left(a + r\right)}^{2}}{2 H} Δ σ tan α ;$$

when

$$H cot α < d ′ < 2 H cot α ,$$

$$\begin{matrix}{P}_{1} = - \frac{{\left(a + r\right)}^{2}}{2} γ tan α - \frac{{\left(a + r\right)}^{2}}{2 H} Δ σ tan α - \frac{γ {H}^{2} tan α}{2} - \\ H Δ σ tan α + γ H {d}^{′} + \frac{3}{2} Δ σ {d}^{′} + \frac{Δ σ {tan}^{2} α}{2 H} {d}^{′} - \frac{Δ σ tan α}{2 H} {{d}^{′}}^{2} ;\end{matrix}$$

and when

$$2 H cot α < d ′$$

$${P}_{1} = \frac{3 γ H + 2 Δ σ}{2} H tan α + γ H D - \frac{{\left(a + r\right)}^{2}}{2} γ tan α - \frac{{\left(a + r\right)}^{2}}{2 H} Δ σ tan α ,$$

u(d′) where represents the piecewise function, while d′ is the width of the gob-side working face, α is the width of the small coal pillar of the gob-side entry, r is the entry width, ρ is a sum of the ruptured zone width and the plastic zone width, n is a confining pressure coefficient for different areas of surrounding rock, [σ] is the uniaxial compressive strength of coal, K is an incremental coefficient (the value of which may be determined according to the actual situation) for stope dynamic-load stress of the gob-side working face, P₁ is dead load stress of the gob-side working face, H is the buried depth of the coal seam, α is the fracture angle, γ is the average capacity of overlying rock above the mining area, Δσ is a maximum increment of stress transferred from different overlying rock strata above the mining area to the gob-side working face, and D is the mining area width.

In actual application, the determining of the solution set based on the values of the parameters of the gob-side working face, the piecewise function, and the predetermined function threshold specifically includes the following steps:

The values of the parameters of the gob-side working face are input into the piecewise function to obtain a function to be solved.

Calculation is performed by letting the function to be solved be less than or equal to the predetermined function threshold to obtain the solution set.

In practical application, a larger ratio of R/P may be more conducive to the prevention and control of rock burst of the working face or the reduction of the anti-burst work of the working face. Generally, R/P<1.5 is used as a “stress” indicator for determining whether the entire working face is stable. If R/P≥1.5, it indicates that the working face is potential to be instable due to overall burst. When R/P is extremely large, it may be impossible to mine the working face. Calculation is performed by letting the function to be solved be less than or equal to the predetermined function threshold to obtain the solution set, and the specific steps are as follows:
(1) According to the synthetic analysis results of the pre-mining mine pressure theory of the gob-side working face, actual monitoring, etc., the movement state or the mining situation of the overlying key rock is determined.
(2) referring to the mining experience or theoretical analysis of a similar mine, the feature changes of the overlying key strata and the spatial structure of the overlying rock during the mining of the gob-side working face are predicted, the specific type (one of NFM-NFM, NFM-FM, and FM-FM) of the gob-side working face is analyzed, and the incremental coefficient K for the stope dynamic-load stress of the gob-side working face is estimated. According to different conditions, K ranges from 0 to 2.0, usually from 0.5 to 1.0.
(3) The function u (d′) of an entitative coal entry is analyzed in different positions, namely in case of 1) (α+r<d′≤Hcotα), 2) (Hcotα<d′≤2Hcotα), and 3) (2Hcotα<d′), respectively. According to the overall burst instability condition of the working face, u(d′) is assumed to be ≥1.5, and the solutions of the inequation are obtained, i.e., the value range of d′ namely the rational width.

In practical application, the mining the gob-side working face according to the rational width specifically includes the following steps:

An actual width of the gob-side working face is determined based on the rational width, the width of the small coal pillar of the gob-side entry, and the entry width.

According to the requirements of leaving coal pillars in a gob-side section and the entry width design, the actual width of the gob-side working face is determined as follows: dᵣ=d′-α-r. Furthermore, the resulting parameter dᵣ is “fed back” to the above step (2) to verify whether the result accords with the movement feature of the overlying key strata under experience or theoretical analysis condition, and the result is optimized and perfected.

The gob-side working face is mined according to the actual width.

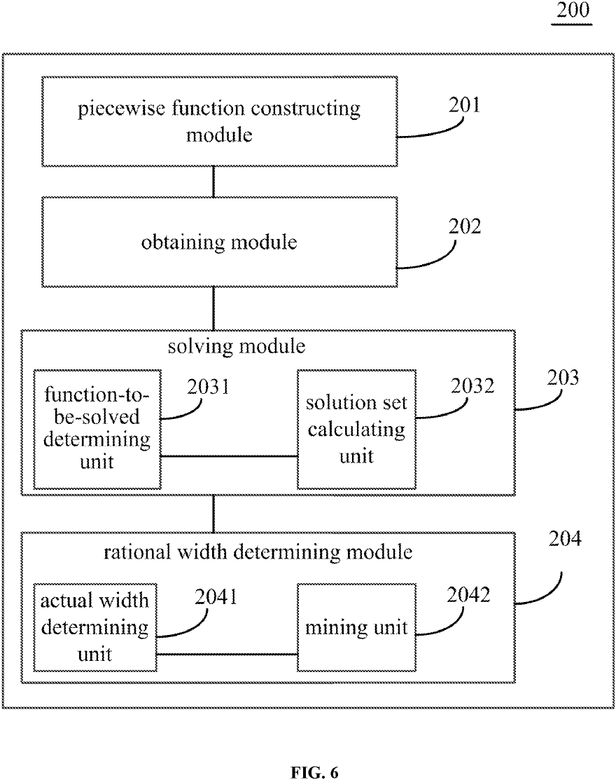

As shown in FIG. 6, a non-limiting embodiment of the present disclosure further provides a system 200 (i.e., shown in the form of a schematic block diagram) for determining a rational width of a gob-side working face under a condition of thick and hard key strata, including:
a piecewise function constructing module 201 configured to construct a piecewise function with a width of a gob-side working face as an independent variable, where the piecewise function represents a relationship among the width of the gob-side working face and parameters of the gob-side working face, the parameters of the gob-side working face including at least a width of a small coal pillar of a gob-side entry, an entry width, a ruptured zone width, a plastic zone width, a uniaxial compressive strength of coal, a buried depth of a coal seam, a fracture angle, an average capacity of overlying rock above a mining area, and a mining area width;
an obtaining module 202 configured to obtain values of the parameters of the gob-side working face;
a solving module 203 configured to determine a solution set based on the values of the parameters of the gob-side working face, the piecewise function, and a predetermined function threshold; and
a rational width determining module 204 configured to determine a numerical value according to the solution set as a rational width and mine the gob-side working face according to the rational width.

As a non-limiting embodiment of the present disclosure, the piecewise function is specifically as follows:

$$u \left({d}^{′}\right) = \frac{\left({d}^{′} - a - r - ρ\right) n \left[σ\right]}{\left(1 + K\right) {P}_{1}} , \text{where}$$

$${\text{when}}^{a + r < {d}^{′} < H \text{cot} α} ,$$

$${P}_{1} = \frac{{{d}^{′}}^{2} \text{-} {\left(a + r\right)}^{2}}{2} γ tan α + \frac{{{d}^{′}}^{2} - {\left(a + r\right)}^{2}}{2 H} Δ σ tan α ;$$

$$\text{when} H cot α < {d}^{′} < 2 H cot α ,$$

$$\begin{matrix}{P}_{1} = \frac{{\left(a + r\right)}^{2}}{2} γ tan α - \frac{{\left(a + r\right)}^{2}}{2 H} Δ σ tan α - \frac{γ {H}^{2} tan α}{2} - H Δ σ tan α + \\ γ H {d}^{′} + \frac{3}{2} Δ σ {d}^{′} + \frac{Δ σ {tan}^{2} α}{2 H} {d}^{′} - \frac{Δ σ tan α}{2 H} {{d}^{′}}^{2} ;\end{matrix}$$

and

$$\text{when} 2 H cot α < {d}^{′} ,$$

$${P}_{1} = \frac{3 γ H + 2 Δ σ}{2} H tan α + γ H D - \frac{{\left(a + r\right)}^{2}}{2} γ tan α - \frac{{\left(a + r\right)}^{2}}{2 H} Δ σ tan α ,$$

where u(d′) represents the piecewise function, while d′ is the width of the gob-side working face, α is the width of the small coal pillar of the gob-side entry, r is the entry width, ρ is a sum of the ruptured zone width and the plastic zone width, n is a confining pressure coefficient for different areas of surrounding rock, [σ] is the uniaxial compressive strength of coal, K is an incremental coefficient for stope dynamic-load stress of the gob-side working face, P₁ is dead load stress of the gob-side working face, H is the buried depth of the coal seam, α is the fracture angle, γ is the average capacity of overlying rock above the mining area, Δσ is a maximum increment of stress transferred from different overlying rock strata above the mining area to the gob-side working face, and D is the mining area width.

As a non-limiting embodiment, the solving module 203 specifically includes:
a function-to-be-solved determining unit 2031 configured to input the values of the parameters of the gob-side working face into the piecewise function to obtain a function to be solved; and
a solution set calculating unit 2032 configured to perform calculation by letting the function to be solved be less than or equal to the predetermined function threshold to obtain the solution set.

As a non-limiting embodiment, the rational width determining module 204 includes:
an actual width determining unit 2041 configured to determine an actual width of the gob-side working face based on the rational width, the width of the small coal pillar of the gob-side entry, and the entry width; and
a mining unit 2042 configured to mine the gob-side working face according to the actual width.

The method and system provided in the present disclosure can obtain a rational width of a gob-side working face and allow for mining of the gob-side working face according to the rational width, and can initiatively reduce the level and area of rock burst hazard of the working face, reduce the amount of anti-burst work, and realize effective prevention and control of rock burst.

The embodiments are described herein in a progressive manner. Each embodiment focuses on the difference from another embodiment, and the same and similar parts between the embodiments may refer to each other. The system disclosed in the embodiments corresponds to the method disclosed in the embodiments. Therefore, the system is described in a relatively simple manner. For the related parts, reference may be made to the description of the method parts.

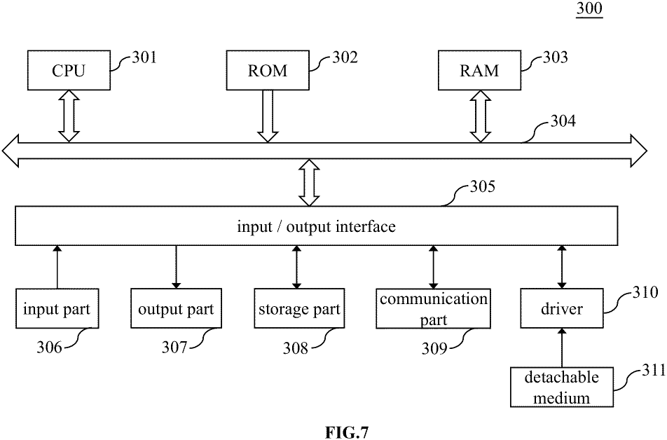

In addition, it should also be noted herein that the respective composite parts in the above system 200 can be configured by software, firmware, hardwire or a combination thereof. Specific means or manners that can be used for the configuration will not be stated repeatedly herein since they are well-known to those skilled in the art. In case of implementation by software or firmware, programs constituting the software are installed from a storage medium or a network to a computer (e.g., the universal computer 300 as shown in FIG. 7) having a dedicated hardware structure; the computer, when installed with various programs, can implement various functions and the like.

FIG. 7 shows a schematic block diagram of a computer 300 that can be used for implementing the method and the system 200 according to the embodiments of the present disclosure.

In FIG. 7, a central processing unit (CPU) 301 executes various processing according to a program stored in a read-only memory (ROM) 302 or a program loaded from a storage part 308 to a random access memory (RAM) 303. In the RAM 303, data needed at the time of execution of various processing and the like by the CPU 301 is also stored according to requirements. The CPU 301, the ROM 302 and the RAM 303 are connected to each other via a bus 304. An input/output interface 305 is also connected to the bus 304.

The following components are connected to the input/output interface 305: an input part 306 (including a keyboard, a mouse and the like); an output part 307 (including a display, such as a Cathode Ray Tube (CRT), a Liquid Crystal Display (LCD) and the like, as well as a loudspeaker and the like); the storage part 308 (including a hard disc and the like); and a communication part 309 (including a network interface card such as an LAN card, a modem and so on). The communication part 309 performs communication processing via a network such as the Internet. According to requirements, a driver 310 may also be connected to the input/output interface 305. A detachable medium 311 such as a magnetic disc, an optical disc, a magnetic optical disc, a semiconductor memory and the like may be installed on the driver 310 according to requirements, such that a computer program read therefrom is installed in the storage part 308 according to requirements.

In the case of carrying out the foregoing series of processing by software, programs constituting the software are installed from a network such as the Internet or a storage medium such as the detachable medium 311.

Those skilled in the art should appreciate that such a storage medium is not limited to the detachable medium 311 storing therein a program and distributed separately from the apparatus to provide the program to a user as shown in FIG. 7. Examples of the detachable medium 311 include a magnetic disc (including floppy disc (registered trademark)), a compact disc (including compact disc read-only memory (CD-ROM) and digital versatile disc (DVD), a magneto optical disc (including mini disc (MD)(registered trademark)), and a semiconductor memory. Or, the storage medium may be hard discs and the like included in the ROM 302 and the storage part 308 in which programs are stored, and are distributed concurrently with the apparatus including them to users.

The present disclosure further proposes a program product storing therein a machine-readable instruction code that, when read and executed by a machine, can implement the aforesaid method according to the embodiment of the present disclosure.

Correspondingly, a storage medium for carrying the program product storing therein the machine-readable instruction code is also included in the disclosure of the present disclosure. The storage medium includes but is not limited to a floppy disc, an optical disc, a magnetic optical disc, a memory card, a memory stick and the like.

It should be noted that, the method according to the present disclosure is not limited to be performed in the temporal order as described in the description, but may also be performed sequentially, in parallel or independently in other orders. Thus, the order of implementing the method as described in the description does not constitute a limitation to the technical scope of the present disclosure.

Specific examples are used herein to explain the principles and embodiments of the present disclosure. The foregoing description of the embodiments is merely intended to help understand the method of the present disclosure and its core ideas; besides, various modifications may be made by a person of ordinary skill in the art to specific embodiments and the scope of application in accordance with the ideas of the present disclosure. In conclusion, the content of the present description shall not be construed as limitations to the present disclosure.

What is claimed is:

1. A method for determining a rational width of a gob-side working face under a condition of thick and hard key strata, comprising:
constructing a piecewise function with a width of a gob-side working face as an independent variable, wherein the piecewise function represents a relationship among the width of the gob-side working face and parameters of the gob-side working face, the parameters of the gob-side working face comprising at least a width of a small coal pillar of a gob-side entry, an entry width, a ruptured zone width, a plastic zone width, a uniaxial compressive strength of coal, a buried depth of a coal seam, a fracture angle, an average capacity of overlying rock above a mining area, and a mining area width;
obtaining values of the parameters of the gob-side working face;
determining a solution set based on the values of the parameters of the gob-side working face, the piecewise function, and a predetermined function threshold; and
determining a numerical value according to the solution set as a rational width and mining the gob-side working face according to the rational width.

2. The method according to claim 1, wherein the piecewise function is as follows:
$$u \left({d}^{′}\right) = \frac{\left({d}^{′} - a - r - ρ\right) n \left[σ\right]}{\left(1 + K\right) {P}_{1}} , \text{wherein}$$
$$\text{when} a + r < {d}^{′} < H cot α ,$$
$${P}_{1} = \frac{{{d}^{′}}^{2} \text{-} {\left(a + r\right)}^{2}}{2} γ tan α + \frac{{{d}^{′}}^{2} - {\left(a + r\right)}^{2}}{2 H} Δ σ tan α \text{;}$$
$$\text{when} H cot α < {d}^{′} < 2 H cot α ,$$
$$\begin{matrix}{P}_{1} = - \frac{{\left(a + r\right)}^{2}}{2} γ tan α - \frac{{\left(a + r\right)}^{2}}{2 H} Δ σ tan α - \frac{γ {H}^{2} tan α}{2} - \\ H Δ σ tan α + γ H {d}^{′} + \frac{3}{2} Δ σ {d}^{′}\end{matrix}$$
$$+ \frac{Δ σ {tan}^{2} α}{2 H} {d}^{′} - \frac{Δ σ tan α}{2 H} {{d}^{′}}^{2} \text{; and}$$
$$\text{when} 2 H cot α < {d}^{′} ,$$
$$\begin{matrix}{P}_{1} = \frac{3 γ H + 2 Δ σ}{2} H tan α + γ H D - \frac{{\left(a + r\right)}^{2}}{2} γ tan α - \\ \frac{{\left(a + r\right)}^{2}}{2 H} Δ σ tan α ,\end{matrix}$$
wherein u(d′) represents the piecewise function, while d′ is the width of the gob-side working face, a is the width of the small coal pillar of the gob-side entry, r is the entry width, ρ is a sum of the ruptured zone width and the plastic zone width, n is a confining pressure coefficient for different areas of surrounding rock, [σ] is the uniaxial compressive strength of coal, K is an incremental coefficient for stope dynamic-load stress of the gob-side working face, P
₁ is dead load stress of the gob-side working face, H is the buried depth of the coal seam, α is the fracture angle, γ is the average capacity of overlying rock above the mining area, Δσ is a maximum increment of stress transferred from different overlying rock strata above the mining area to the gob-side working face, and D is the mining area width.

3. The method according to claim 1, wherein the determining the solution set based on the values of the parameters of the gob-side working face, the piecewise function, and the predetermined function threshold comprises:
inputting the values of the parameters of the gob-side working face into the piecewise function to obtain a function to be solved; and
performing calculation by letting the function to be solved be less than or equal to the predetermined function threshold to obtain the solution set.

4. The method according to claim 1, wherein the mining the gob-side working face according to the rational width comprises:
determining an actual width of the gob-side working face based on the rational width, the width of the small coal pillar of the gob-side entry, and the entry width; and
mining the gob-side working face according to the actual width.

5. A system for determining a rational width of a gob-side working face under a condition of thick and hard key strata, comprising:
a piecewise function constructing module configured to construct a piecewise function with a width of a gob-side working face as an independent variable, wherein the piecewise function represents a relationship among the width of the gob-side working face and parameters of the gob-side working face, the parameters of the gob-side working face comprising at least a width of a small coal pillar of a gob-side entry, an entry width, a ruptured zone width, a plastic zone width, a uniaxial compressive strength of coal, a buried depth of a coal seam, a fracture angle, an average capacity of overlying rock above a mining area, and a mining area width;
an obtaining module configured to obtain values of the parameters of the gob-side working face;
a solving module configured to determine a solution set based on the values of the parameters of the gob-side working face, the piecewise function, and a predetermined function threshold; and
a rational width determining module configured to determine a numerical value according to the solution set as a rational width and mine the gob-side working face according to the rational width.

6. The system according to claim 5, wherein the piecewise function is as follows:
$$u \left({d}^{′}\right) = \frac{\left({d}^{′} - a - r - ρ\right) n \left[σ\right]}{\left(1 + K\right) {P}_{1}} , \text{wherein}$$
$$\text{when} a + r < {d}^{′} < H cot α ,$$
$${P}_{1} = \frac{{{d}^{′}}^{2} \text{-} {\left(a + r\right)}^{2}}{2} γ tan α + \frac{{{d}^{′}}^{2} - {\left(a + r\right)}^{2}}{2 H} Δ σ tan α ;$$
$$\text{when} H cot α < {d}^{′} < 2 H cot α ,$$
$$\begin{matrix}{P}_{1} = - \frac{{\left(a + r\right)}^{2}}{2} γ tan α - \frac{{\left(a + r\right)}^{2}}{2 H} Δ σ tan α - \frac{γ {H}^{2} tan α}{2} - \\ H Δ σ tan α + γ H {d}^{′} + \frac{3}{2} Δ σ {d}^{′}\end{matrix}$$
$$+ \frac{Δ σ {tan}^{2} α}{2 H} {d}^{′} - \frac{Δ σ tan α}{2 H} {{d}^{′}}^{2} \text{; and}$$
$$\text{when} 2 H cot α < {d}^{′} ,$$
$$\begin{matrix}{P}_{1} = \frac{3 γ H + 2 Δ σ}{2} H tan α + γ H D - \frac{{\left(a + r\right)}^{2}}{2} γ tan α - \\ \frac{{\left(a + r\right)}^{2}}{2 H} Δ σ tan α ,\end{matrix}$$
wherein u(d′) represents the piecewise function, while d′ is the width of the gob-side working face, a is the width of the small coal pillar of the gob-side entry, r is the entry width, ρ is a sum of the ruptured zone width and the plastic zone width, n is a confining pressure coefficient for different areas of surrounding rock, [σ] is the uniaxial compressive strength of coal, K is an incremental coefficient for stope dynamic-load stress of the gob-side working face, P
₁ is dead load stress of the gob-side working face, H is the buried depth of the coal seam, α is the fracture angle, γ is the average capacity of overlying rock above the mining area, Δσ is a maximum increment of stress transferred from different overlying rock strata above the mining area to the gob-side working face, and D is the mining area width.

7. The system according to claim 5, wherein the solving module comprises:
a function-to-be-solved determining unit configured to input the values of the parameters of the gob-side working face into the piecewise function to obtain a function to be solved; and
a solution set calculating unit configured to perform calculation by letting the function to be solved be less than or equal to the predetermined function threshold to obtain the solution set.

8. The system according to claim 5, wherein the rational width determining module comprises:
an actual width determining unit configured to determine an actual width of the gob-side working face based on the rational width, the width of the small coal pillar of the gob-side entry, and the entry width; and
a mining unit configured to mine the gob-side working face according to the actual width.
